(19) United States
(12) Patent Application Publication
(10) Pub. No.: US 2017/0142638 A1
(43) Pub. Date: May 18, 2017

(54) ACCESS POINT FOR FACILITATING CONNECTION OF ONE OR MORE WIRELESS USER DEVICES TO A COMMUNICATIONS CHANNEL

(71) Applicant: KABUSHIKI KAISHA TOSHIBA, Tokyo (JP)

(72) Inventors: Stephen WANG, Bristol (GB); Fengming CAO, Bristol (GB)

(73) Assignee: Kabushiki Kaisha Toshiba, Tokyo (JP)

(21) Appl. No.: 15/124,732

(22) PCT Filed: Jun. 2, 2014
(86) PCT No.: PCT/GB2014/051680

§ 371 Date: Sep. 9, 2016

(51) Int. Cl. H04W 48/06; H04W 12/06; H04W 72/04

(52) U.S. Cl. CPC H04W 48/06; H04W 72/048; H04W 12/06; H04W 72/0446; H04W 72/0486; H04W 88/10

(57) ABSTRACT

An access point for facilitating connection of one or more wireless user devices to a first communications channel and operable to allocate resources to said user devices, the access point comprising a user device authenticator for determining whether a user device is in possession of pre-determined user device authentication information for obtaining access to the first communications channel, the access point having first and second modes of operation, wherein in the first mode of operation, the entirety of said resources is available for use by all user devices and in the second mode of operation, a portion of the resources is reserved for user devices that are in possession of the device authentication information; the access point being configured to switch the mode of operation when one or more mode switch criteria are met, wherein one of the mode switch criteria is based on the current demand for resources.

### FIELD

Embodiments described herein relate generally to an access point for facilitating connection of one or more wireless user devices to a communications channel.

### BACKGROUND

An access point (AP) is a device that provides other user devices, such as PCs, mobile phones, tablet computers, for example, with access to a network such as the internet. The access point may facilitate connection of those user devices to the network by establishing a wireless communications channel between those devices and the access point. When connecting more than one user device to the network, the access point may allocate resources between those user devices; such resources include, for example, the bandwidth of the wireless communications channel, storage memory, battery power etc.

The access point may be configured to operate in a closed access mode, in which the access point only serves devices that have the requisite authorisation, including knowledge of any required encryptions keys. Alternatively, an access point may be configured to operate in an open mode, in which the access point will facilitate connection of any user device to the network, regardless of whether or not the user device in question has access to such keys or other authentication information.

Where access points are deployed arbitrarily in an indoor environment, the limited frequency channel resources available mean that some access points may suffer from excessive aggregated channel interference from neighbouring access points with OBSS (overlapping basic service sets). Access points may also become overloaded with requests for resources from user devices seeking to connect to the network. Together, these factors may result in network congestion and poor service, particularly in the context of high-density Wireless Local Area Networks (VVLANs).

To address the heavy load and OBSS issues, load management schemes have been suggested for allocating user devices to different access points. However, such load management methods are typically based on the premise that the access points will always operate in an open mode; these methods ignore the fact that in any given wireless network, the majority of access points may be privately owned and configured to operate in a closed mode, in which only user devices having the requisite authentication information will be served.

### BRIEF DESCRIPTION OF FIGURES

Embodiments of the invention will now be described by way of example with reference to the accompanying drawings in which:

FIG. 1 shows an access point according to a first embodiment;

FIG. 2 shows an example of how an access point may reserve a portion of its resources for user devices that are in possession of predetermined user device authentication information when operating in a closed mode, as compared to an open mode of operation;

FIG. 3 shows an example of how the portion of the resources that is reserved may change over time when the access point is operating in a closed mode;

FIG. 4 shows an example of steps carried out by an access point in an embodiment;

FIG. 5 shows an example of mode criteria assessed by an access point when determining whether to switch from an open mode of operation to a closed mode of operation, according to an embodiment;

FIG. 6 shows an example of mode criteria assessed by an access point when determining whether to switch from an open mode of operation to a closed mode of operation, according to an embodiment;

FIG. 7 shows a continuation of steps carried out by an access point in the embodiment of FIG. 6;

FIG. 8 shows a continuation of steps carried out by an access point in the embodiment of FIG. 6;

FIG. 9 shows an example of steps carried out by access point for determining whether to switch from an open mode to a closed mode of operation immediately, or to defer switching from the open mode to the closed mode for a predetermined period, according to an embodiment;

FIG. 10 shows an example of mode criteria assessed by an access point when determining whether to switch from a closed mode to an open mode of operation according to an embodiment;

FIG. 11 shows an example of mode criteria assessed by an access point when determining whether to switch from a closed mode to an open mode of operation according to an embodiment;

FIG. 12 shows an example of mode criteria assessed by an access point when determining whether to switch from a closed mode to an open mode of operation according to an embodiment;

FIG. 13 shows an example of steps carried out by access point for determining whether to switch from a closed mode to an open mode of operation immediately, or to defer switching from the closed mode to the open mode for a predetermined period, according to an embodiment;

FIG. 14 shows a continuation of steps carried out by an access point in the embodiment of FIG. 13;

FIG. 15 shows a continuation of steps carried out by an access point in the embodiment of FIG. 13;

FIG. 16 shows a summary of actions carried out by an access point based on its current mode of operation and the current level of demand for its resources; and

FIG. 17 shows an access point according to an embodiment.

### DETAILED DESCRIPTION

According to a first embodiment, there is provided an access point for facilitating connection of one or more wireless user devices to a first communications channel, the access point being operable to allocate resources to user devices seeking to connect to the communications channel, the access point comprising:

a user device authenticator for determining whether a user device connecting to the access point is in possession of pre-determined user device authentication information for obtaining access to the first communications channel;

the access point having first and second modes of operation, wherein in the first mode of operation, the entirety of said resources is available for use by user devices regardless of whether or not the user devices are in possession of the authentication information and in the second mode of operation, the access point is configured to reserve a portion of the resources for user devices that are in possession of the device authentication information;

the access point comprising a mode switching module for switching the mode of operation of the access point, the mode switching module being configured to switch the mode of operation when one or more mode switch criteria are met;

wherein a first one of the mode switch criteria is based on the current demand for resources that the access point is receiving from user devices.

In some embodiments, the access point is operable to establish a wireless communications channel through which the one or more user devices may connect to the access point and achieve access to the first communications channel, wherein the resources include the bandwidth of the wireless communications channel;

wherein in the first mode of operation, the entire bandwidth of the wireless communications channel is available for use by user devices regardless of whether or not the user devices are in possession of the authentication information and in the second mode of operation, the access point is configured to reserve a portion of the bandwidth for user devices that are in possession of the device authentication information;

wherein the first one of the mode switch criteria is based on the current demand for the bandwidth that the access point is receiving from user devices.

In some embodiments, the mode switching module is configured to assess the level of demand from user devices at successive intervals in time.

In some embodiments, when the access point is operating in the first mode and the demand for resources reaches a first threshold during one of the intervals, the mode switching module is configured to immediately switch the access point to the second mode of operation.

In some embodiments, when the access point is operating in the first mode and demand for resources reaches a level below the first threshold but above a second threshold during one of the intervals, the mode switching module is configured to determine whether information for estimating a future level of demand on the access point is available;

wherein in the event that the information is not available, the mode switching module is configured to immediately switch the access point to the second mode of operation.

In some embodiments, in the event that the access point has switched from operating in the first mode to operating in the second mode and the demand for resources subsequently falls below the second threshold during one of the intervals, the access point is configured to switch the access point back to the first mode immediately.

In some embodiments, in the event that the information for estimating a future level of demand is available, the mode switching module is configured to switch the access point to the second mode of operation and to define a maximum period of time for which the access point will remain in the second mode before switching back to the first mode.

In some embodiments, the mode switching module is configured to use the information for estimating the future load to determine whether to switch to the second mode immediately, or to defer switching the access point to the second mode for a predetermined period.

In some embodiments, when the access point is operating in the second mode and demand for resources reaches a first threshold during one of the intervals, the mode switching module is configured to transmit a mode-switch request to a neighbouring access point having corresponding first and second modes of operation, so as to request the neighbouring access point to switch from the second mode to the first mode of operation.

In some embodiments, when the access point is operating in the second mode and the demand for resources remains below a threshold at the end of an interval, the access point is configured to determine if a second mode switch criterion has been met by determining if a mode-switch request has been received from a neighbouring access point in the present interval. In some embodiments, when the access point is operating in the second mode and the demand for resources is above the threshold at the end of the interval, the access point is configured to continue operating in the second mode regardless of whether or not a mode-switch request has been received from a neighbouring access point in the present interval.

In some embodiments, in the event that a mode switch request has been received in the present interval, the mode switching module is configured to determine whether information for estimating a future level of demand is available;

wherein in the event that the information is not available, the mode switching module is configured to immediately switch the access point to the first mode of operation.

In some embodiments, in the event that the information for estimating a future level of demand is available, the mode switching module is configured to use the information to determine whether the access point can switch to the first mode immediately, or whether it should delay switching to the first mode of operation by a predetermined period.

In some embodiments, in the event the access point determines it should delay switching to the first mode of operation, the access point is configured to inform the neighbouring access point of the delay and to await a response from the neighbouring access point, wherein in the event the access point does not receive a positive response from the neighbouring access point within the predetermined period, the access point is configured to remain in the second mode.

In some embodiments, on switching to the first mode, the mode switching module is configured to define a maximum period of time for which the access point will operate in the first mode, before being switched back to the second mode.

In some embodiments, the access point is configured such that, during operation in the second mode of operation, the portion of the resources that is reserved for user devices that are in possession of the device authentication information can be varied.

In some embodiments, when operating in the second mode, the portion of the resources that is reserved for user devices that are in possession of the device authentication information is determined based on the demand for resources from user devices that are connected to the network via the access point and which are in possession of the user device authentication information at the point of switching from the first mode to the second mode.

In some embodiments, the first threshold is variable over time. In some embodiments, the second threshold is variable over time.

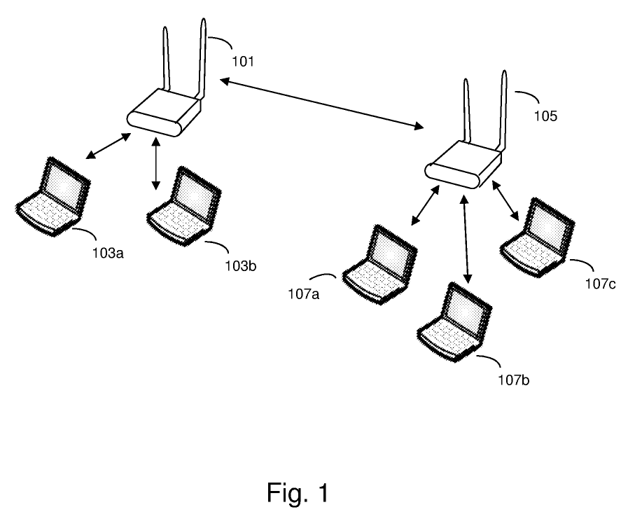

FIG. 1 shows an example of an access point 101 according to an embodiment. The access point 101 serves as a port for connecting wireless user devices 103a, 103b to a first communications channel, which may be part of a larger network, for example. The access point is operable to establish a second, wireless communications channel through which the user devices may connect to the access point and in turn obtain access to the first communications channel, thereby allowing those devices to upload and/or download data to and from the network. When connecting the user devices to the network, the access point may allocate its resources between those user devices; these resources may include the bandwidth available in the wireless communications channel, computing components such as storage memory, and/or battery power (i.e. the access point may devote a greater share of its battery power to servicing certain ones of the user devices). Although the user devices 103a, 103b are shown in FIG. 1 as being laptop computers, the access point may also facilitate connection of other types of device, such as mobile phones, tablet computers, personal media players etc. to the network.

The access point 101 may operate in one of two modes: an open mode and a closed mode. When operating in the open mode, a null authentication algorithm is employed by the access point; that is, any user device requesting access to the first communications channel may be authenticated and granted access to the resources by the access point. In contrast, when operating in the closed mode, a portion of the access point's resources is reserved for users that are in possession of predetermined user device authentication information.

The pre-determined user device authentication information may be any type of information that identifies the user device as being entitled to use the reserved portion of the access point's resources. The user device authentication information may comprise a pre-determined data sequence or message that is transmitted from the user device to the access point. For example, the authentication information may comprise a cookie that is transmitted between the user device and the access point. The data sequence may comprise a key for use in a shared key algorithm. The data sequence or message may be transmitted as part of the request to connect to the access point, or in response to a request from the access point.

In some embodiments, the access point may store a list of authorised user devices. Where the access point stores such a list, the authentication information may be information that identifies the user device as one of the list of authorised user devices. For example, the authentication information may be provided as a serial number or other identity label of the user device. The authentication information may comprise a MAC address or IMEI (International Mobile Station Equipment Identity) number of the user device.

A user may obtain the authentication information through payment of a subscription fee to a network service provider that is responsible for maintaining the first communications channel, for example. The subscription may be managed on a fixed term basis e.g. by paying a certain fee for a month or year's subscription, or alternatively in the form of a pay-as-you-go subscription.

Referring still to FIG. 1, there is shown a second access point 105 that is serving user devices 107a, 107b, 107c. The two access points 101, 105 are able to communicate with one another and to convey information concerning the current demand for resources that they are experiencing from the user devices that they are each serving. Either access point may switch between the open and closed modes in response to changes in the demand for resources that it or its neighbouring access point is experiencing.

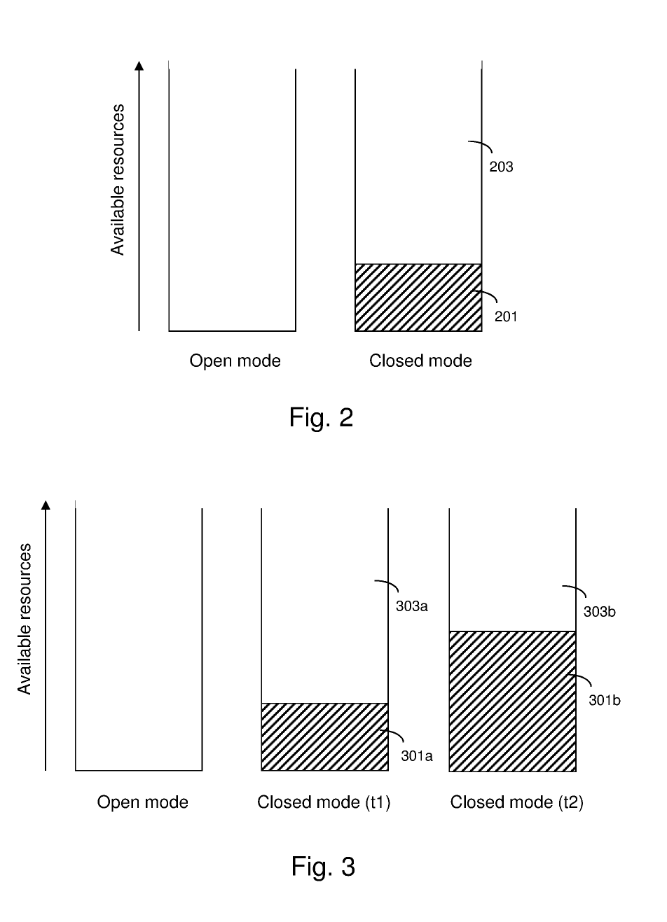

The difference between the open and closed modes is shown pictorially in FIG. 2. In the open mode, the full extent of the access point's resources is available for use by recognised and unrecognised user devices alike (here the term “recognised user device” is used as a shorthand for a user device that is in possession of the predetermined authentication information, whilst the term “unrecognised user device” refers to one that is not in possession of the predetermined authentication information). In the closed mode, a portion of the access point's resources (shown here by the shaded region 201) is reserved for recognised user devices. The remaining portion 203 is then available for use by unrecognised user devices. In some embodiments, the remaining portion may also be available for use by other recognised user devices.

In one embodiment the portion 201 of the access point's resources that is reserved for recognised user devices will be set as that which is already allocated to recognised user devices at the point in time at which the access point switches from open mode to closed mode. The remaining portion of the resources may then be allocated to the other (unrecognised) user devices that were connected to the access point at the time the access point switched modes. For example, where the resources include the bandwidth of the wireless communication channel between the user devices and the access point, once the access point has switched to closed mode the access point may cease to accept any new connection requests, regardless of whether or not those requests come from recognised user devices. Here, only unrecognised user devices will be allowed access to the “unreserved” portion since by definition, all recognised user devices will have already been allocated the reserved portion of the resources.

In an alternative embodiment, the access point may allow recognised user devices to access the portion of the resources that is not specifically reserved for recognised user devices. The access point may allocate resources to these new recognised user devices at the expense of unrecognised user devices that are currently connected. For example, on switching from open mode to closed mode, the access point may check which ones of the user devices that are currently connected are recognised user devices and which are not by issuing a request to each device to (re)send the authentication information. In the event that a particular user device fails to send the authentication information within a certain period of time, the access point may determine that user device to be an unrecognised device and, depending on the demand for resources from other user devices, may choose to disconnect the user device. Thereafter, the access point will decline any new connection requests from other unrecognised user devices.

When operating in the closed mode, the access point may vary the portion of its resources that is reserved for recognised user devices. Depending on the real-time load status, the resource allocation ratio can be changed at different time periods accordingly; that is, the portion of the resources that is reserved for recognised user devices may be increased or decreased by jointly considering the load on the access point and its neighbouring access points load on a periodic basis. In one example, when operating in the closed mode, the access point may dedicate 10% bandwidth exclusively for recognised user devices in a first interval, then switch to dedicating 50% bandwidth to recognised devices exclusively in a second interval, before switching to reserving 100% of its bandwidth for recognised devices in a third interval. Each access point may use its beacon signals to communicate the load that it is currently experiencing to other neighbouring access points.

FIG. 3 shows an example of how the portion of resources that is reserved for recognised devices may change over time when the access point is operating in the closed mode. As in FIG. 2, when the access point is in the open mode, the full extent of the access point's resources is available for use by recognised and unrecognised devices alike. On entering the closed mode at time t1, a portion 301a of the access point's resources is reserved for recognised user devices, whilst the remaining portion 303a is available for use by both recognised and unrecognised user devices. Subsequently, at time t2, the portion 301b of the access point's resources that is reserved for recognised user devices is increased, whilst the remaining portion 303b that is available for use by both recognised and unrecognised user devices is correspondingly reduced.

It will be understood that, by varying the portion of resources that is reserved for recognised users, the access point does not set an upper limit on the number of recognised devices that can connect to the network; once the reserved portion has been fully allocated to one or more recognised user devices, it is still possible for other recognised user devices to take advantage of the unreserved portion of the access point's resources. User devices that are not recognised will only be able to connect to the network if the access point has spare capacity in the portion of its resources that is not reserved for recognised user devices.

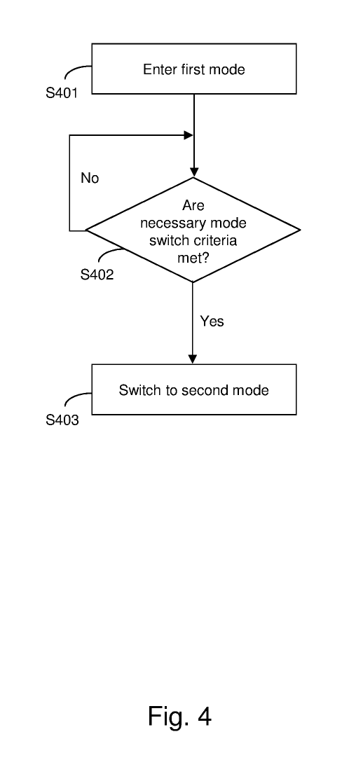

FIG. 4 shows an example of steps carried out by an access point in an embodiment. In step S401, the access point enters a first mode of operation, which might be either an open mode or closed mode of operation as described above. At some point after having entered the first mode, the access point determines whether one or more criteria for switching modes have been met (step S402). In the event that necessary mode switch criteria have not been met, the access point remains in the first mode, but continues to check if mode switch criteria have been met at intervals thereafter. In the event that necessary mode switch criteria have been met, the access point switches to operating in the other of the open and closed modes (step S403).

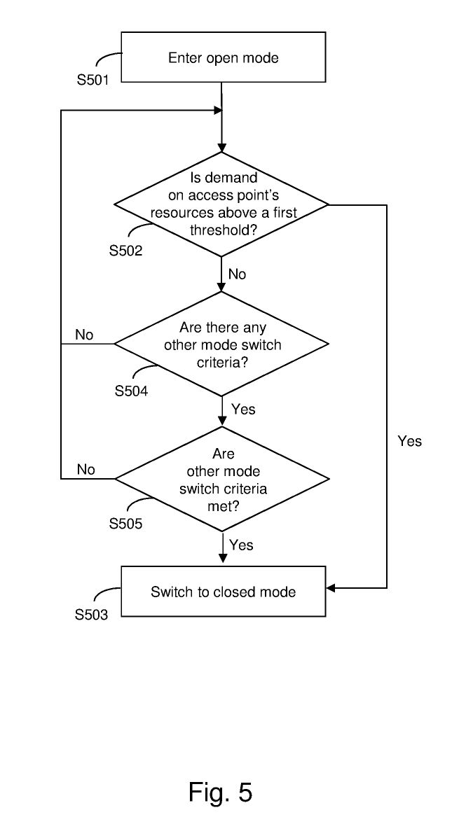

In some embodiments, the access point will be initialised to function in the open mode; that is on powering up, the access point will revert to the open mode by default. Examples of such embodiments will now be described with reference to FIGS. 5 to 9, in which mode criteria are used to prompt the switch from the open mode to the closed mode.

Referring to FIG. 5, the access point begins by entering the first (open) mode of operation (step S501). The access point then assesses a first mode switch criterion by determining whether the demand on its resources from those user devices that it is currently serving exceeds a first threshold (step S502). In the event that the demand exceeds the first threshold, the access point switches to the second (closed) mode (step S503).

It is possible that the access point may still switch to the second (closed) mode of operation even if the first mode switch criterion is not met. For example, there may be other mode switch criteria that if satisfied, will prompt the switch from the first (open) mode to the second (closed) mode. As shown in FIG. 5, in the event that the demand on the access point's resources is below the first threshold, the access point determines if there are any alternative mode switch criteria (step S504) and if so, whether those criteria are met (step S505). In the event that there are alternative mode switch criteria and those criteria are met, the access point switches to the second (closed) mode (step S503). Otherwise, the access point remains in the first mode, but continues to check if the mode switch criteria are met at intervals thereafter.

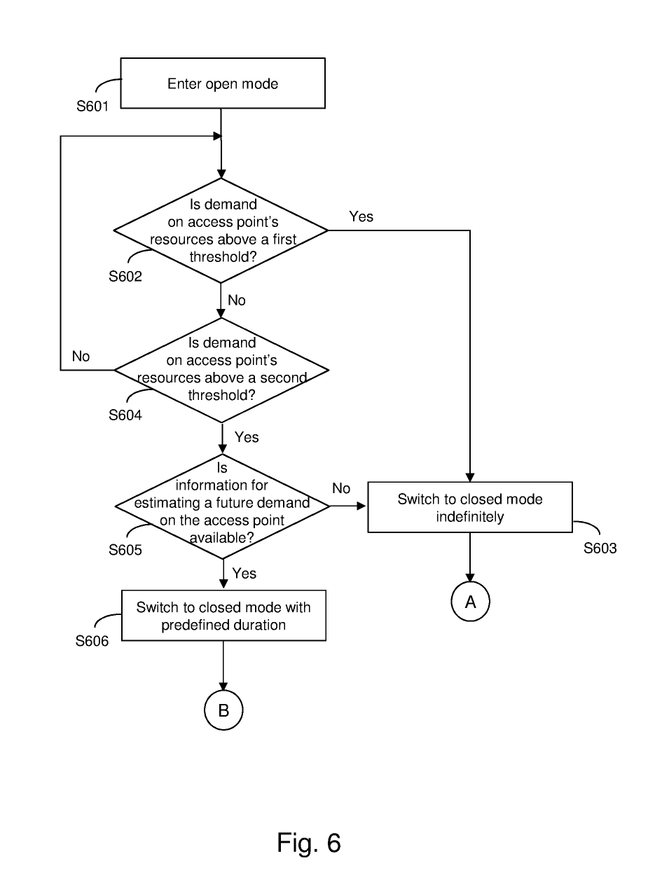

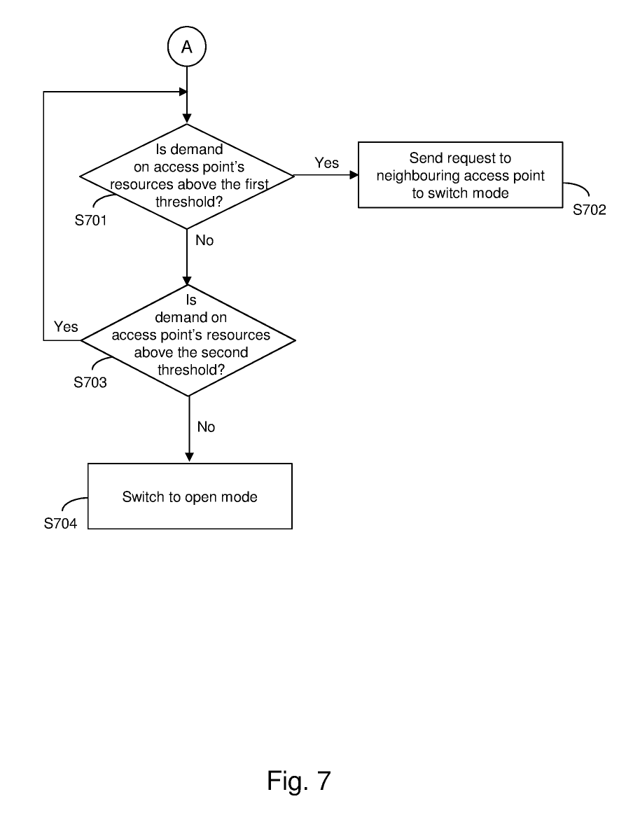

FIG. 6 shows an example of how additional mode criteria may be used to prompt the switch from the first (open) mode to the second (closed) mode of operation, in the event that the current demand on the access point's resources does not exceed the first threshold. As before, having entered the first (open) mode of operation (step S601), the access point determines whether the demand on its resources from user devices that it is currently serving exceeds the first threshold (Step S602). In the event that the demand exceeds the first threshold, the access point switches to the second (closed) mode (Step S603). In this particular embodiment, having entered the second (closed) mode at this point, the access point remains in that second mode indefinitely, pending a fall in the demand for its resources—this scenario is discussed further with reference to FIG. 7, below.

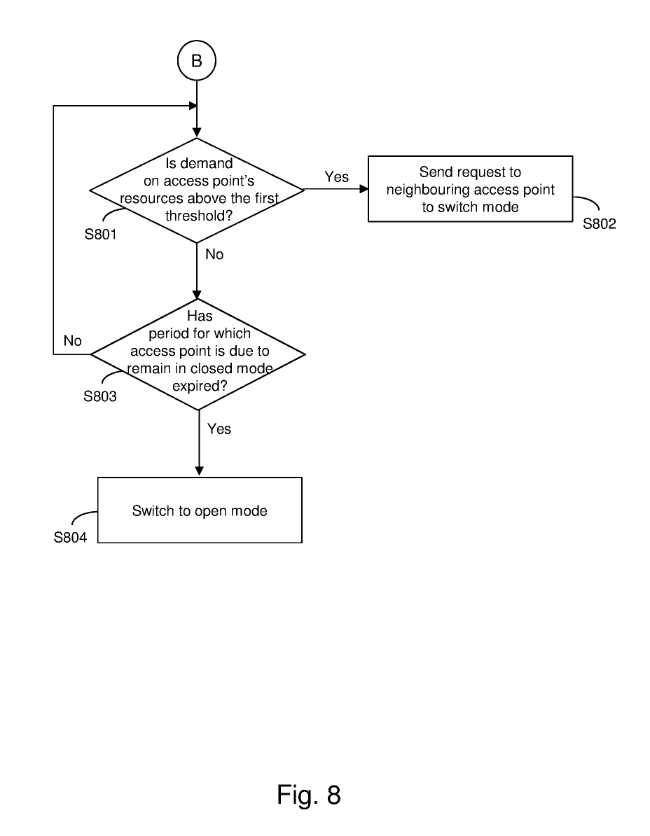

In the event that the demand on the access point's resources is below the first threshold, the access point proceeds to determine whether or not the demand is above a second threshold that is lower than the first threshold (step S604). If the demand is above the second threshold, the access point determines whether or not information for estimating a future demand on the access point is available (Step S605). For example, the access point may have access to a load database that contains a combination of long-term (weeks+) historical load records and a short-term (e.g. 24 hours) load records, either of which can be used to estimate the likely demand on the access point for the immediate future. The database may be stored locally at the access point, or downloaded from a remote server. If such information is not available, the access point switches to the second (closed) mode (step S603), and again remains in that mode indefinitely, pending a fall in the demand for its resources. If information for estimating the future demand on the access point is available, the access point switches to the second (closed) mode (step S606), but now defines a maximum duration that it will remain in the second (closed) mode before switching back to the first (open) mode—this scenario is discussed further with reference to FIG. 8 below.

FIG. 7 shows an example of steps carried out by the access point following the switch to the closed mode in step S603 of FIG. 6. Having entered the closed mode, the access point will continue to operate in that mode indefinitely, pending a change in the demand for its resources from user devices. In step S701, the access point determines whether the demand for its resources in the current interval is above the first threshold. If so, the access point remains in the closed mode and sends a request to one or more neighbouring access points to switch from the closed mode to the open mode (step S702); in this way, the access point communicates that it is experiencing excessive demand for its resources and seeks to offload some of that demand to those other access points. If the demand on the access point's resources is below the first threshold, the access point determines if the demand is above the second (lower) threshold (step S703). If so, the access point remains in the closed mode, without issuing a request to neighbouring access points to switch mode. If the demand on the access point's resources has fallen below the second threshold, the access point switches to the open mode (step S704).

FIG. 8 shows an example of steps carried out by the access point following the switch to the closed mode in step S606 of FIG. 6. Having entered the closed mode, the access point will remain in that mode for a fixed period, where the duration of that period is determined based on the estimated future demand for the access point's resources. In step S801, the access point determines whether the demand for its resources in the current interval is above the first threshold. If so, the access point remains in the closed mode and sends a request to one or more neighbouring access points to switch from the closed mode to the open mode (step S802); in this way, the access point communicates that it is experiencing excessive demand for its resources and seeks to offload some of that demand to those other access points. If the demand on the access point's resources is below the first threshold, the access point determines if the period for which the access point is due to remain in the closed mode has expired (step S803). If not, the access point remains in the closed mode. If the period has expired, then the access point switches to the open mode (step S804).

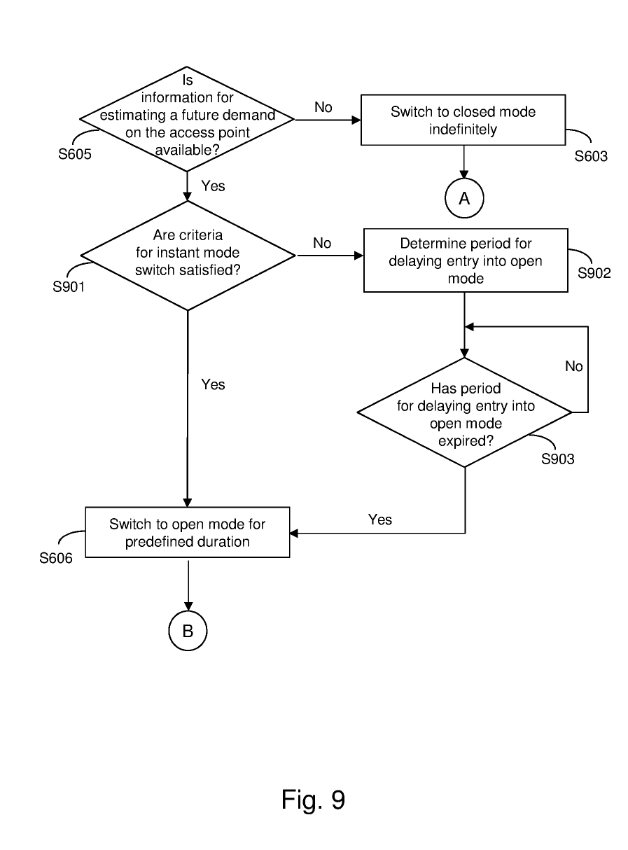

Referring back to FIG. 6, in some embodiments, where the information for estimating the future load on the access point is found to be available in step S605, the access point may execute an intermediate set of steps for determining whether to proceed to step S606 immediately (i.e. to switch from the open mode to the closed mode immediately) or whether to defer doing so for a set period of time. FIG. 9 shows an example of how this might work in practice; following the determination that the information for estimating the future demand on the access point is available in step S606, the access point uses the information to assess whether criteria for switching to the second mode instantly are satisfied (step S901). In the event that those criteria are not satisfied, the access point determines a length of time it should wait for before switching from the open mode to the closed mode (step S902). The access point then waits until that period has expired before switching to the closed mode (steps S903 and S606). By contrast, if the access point determines in step S901 that the mode switch criteria for an instant mode switch are satisfied, the access point proceeds immediately to step S606 and switches to the open mode without delay.

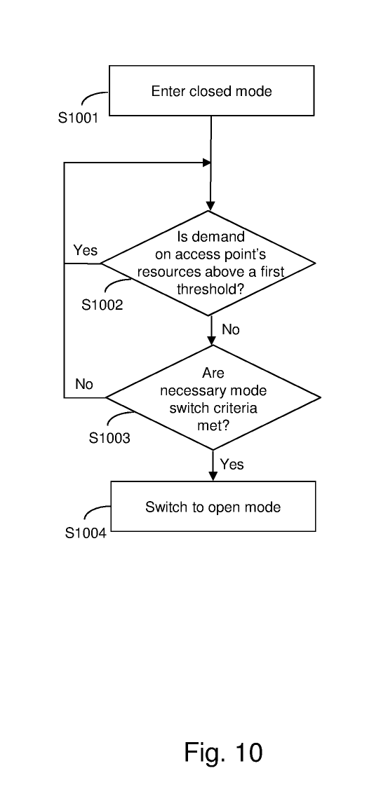

Another embodiment will now be described with reference to FIGS. 10 to 15, in which mode criteria are used to prompt the switch from the closed mode to the open mode. In order for the access point to consider switching to the open mode, the access point must have a certain degree of spare capacity in its resources; thus, one of the mode switching criteria that must be satisfied before switching is that the current demand on the access point's resources does not exceed a threshold. FIG. 10 shows an example of how this might work in practice: having entered the closed mode of operation (step S1001), the access point determines whether the demand for its resources in the current interval is above a threshold (step S1002). If so, the access point remains in the closed mode. In the event that the demand on the access point's resources is below the threshold, the access point determines if there are any additional mode switch criteria and if so, whether those criteria are met (step S1003). In the event that the additional mode switch criteria are met, the access point switches to the open mode (step S1004). Otherwise, the access point remains in the closed mode, but continues to check if the mode switch criteria are met at intervals thereafter.

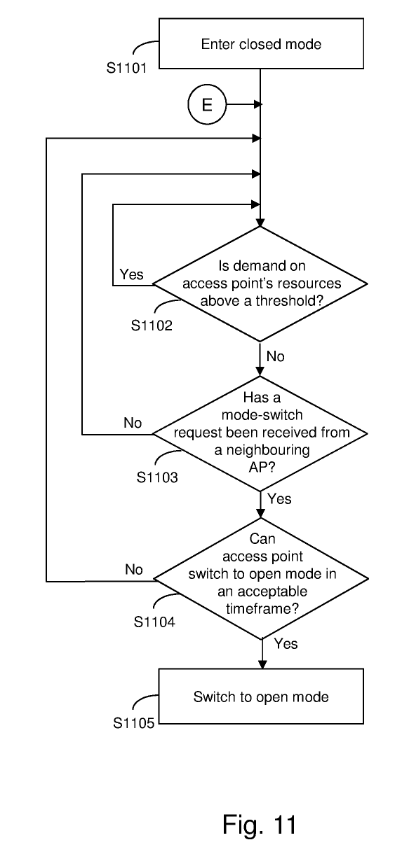

FIG. 11 shows an example of additional mode switch criteria that may be used to prompt the switch from the closed mode to the open mode of operation, in the event that the current demand on the access point's resources does not exceed the first threshold. As in FIG. 10, having entered the first (open) mode of operation (step S1101), the access point determines whether the demand on its resources from user devices that it is currently serving exceeds the first threshold (Step S1102). In the event that the demand on the access point's resources is below the first threshold, the access point proceeds to determine whether or not a mode-switch request has been received from a neighbouring access point (S1103). If no such request has been received in the present time interval, the access point remains in the closed mode until the next time interval. If a mode switch request has been received, the access point may switch to the open mode. Whether or not the access point switches to the open mode may depend on further criteria. These criteria may include, for example, whether or not the access point is willing or able to switch to the open mode immediately or whether the access point determines to defer switching for a given period of time (step S1104); in the event that the access point is able to switch to the open mode in a time frame that is acceptable for the neighbouring access point, the access point will duly switch to the open mode (step S1105).

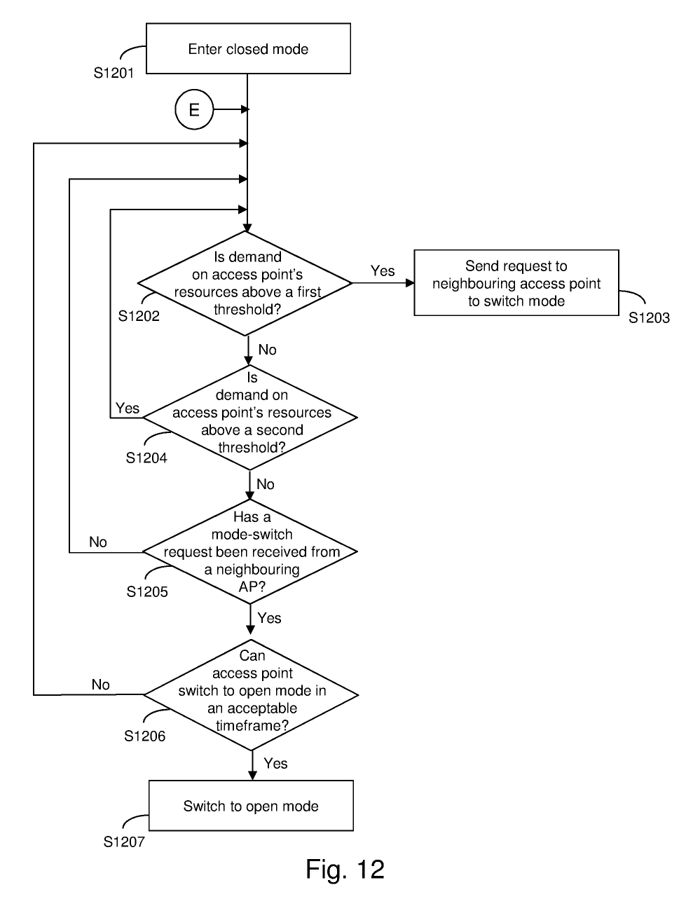

It is possible that the access point itself may be experiencing a high level of demand for its resources and may need to request assistance from other, neighbouring access points. In this case, before determining whether the access point has enough capacity to accept a mode switch request from another access point (i.e. before determining if the demand on the access point is above the threshold shown in step S1102 of FIG. 11), the access point may determine if the demand it is receiving from user devices is above a second, higher, threshold, such that the access point is not only unable to accept mode switch requests, but further needs to issue such a mode switch request itself. FIG. 12 shows how this might be implemented in practice. In this case, steps S1204-S1207 correspond to respective steps S1102-S1105 in FIG. 11. It will be noted that, in comparison with FIG. 11, FIG. 12 includes an additional step S1202 for determining if the demand on the access point's resources is high enough to warrant sending a mode-switch request to another, neighbouring access point. Thus, in this case, a dual threshold test is employed when determining whether to switch from the closed mode to the open mode.

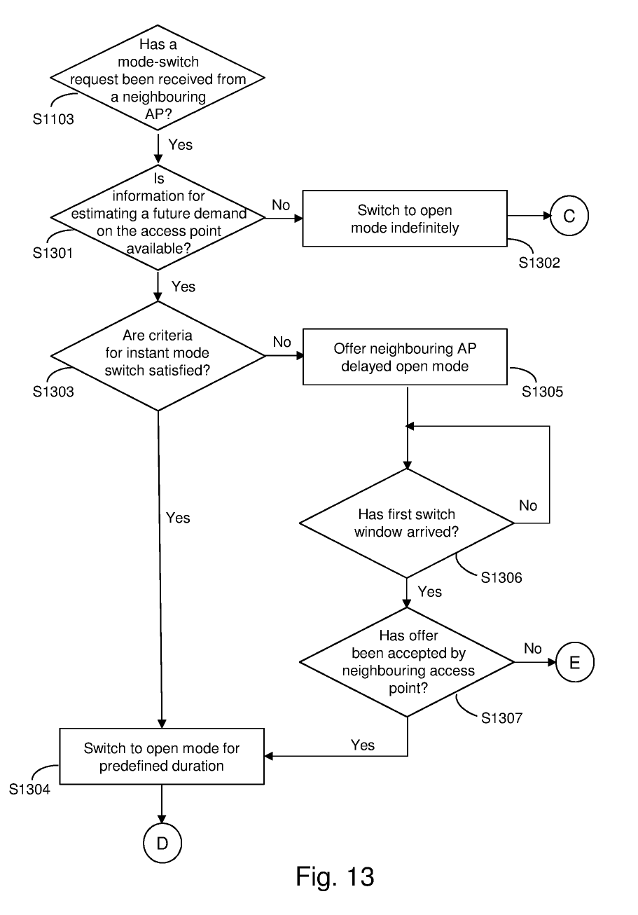

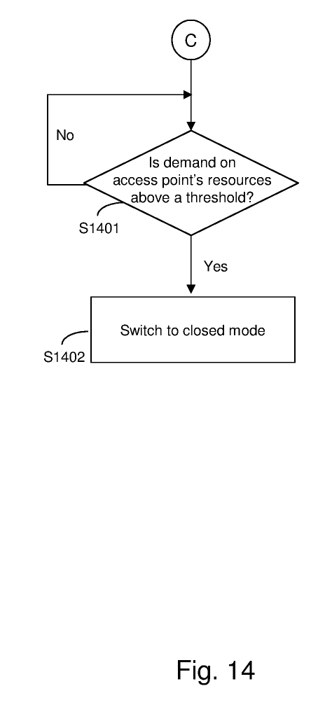

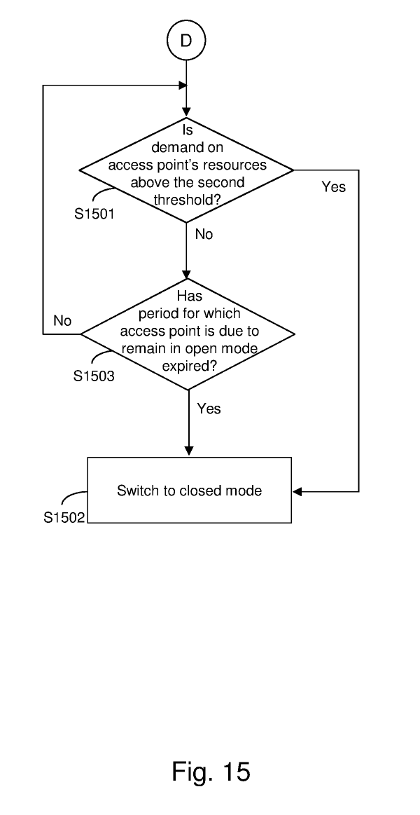

The step of determining whether or not the access point can switch to the open mode in an acceptable timeframe (step S1104, S1206) may itself comprise a number of intermediate steps, examples of which are shown in FIG. 13. On determining that a mode switch request has been received from a neighbouring node in step S1103 of FIG. 11 (or step S1205 in FIG. 12), the access point determines whether or not information for estimating a future demand on the access point is available (step S1301). As in embodiments previously discussed, the access point may have access to a load database that contains a combination of long-term (weeks+) historical load records and a short-term (e.g. 24 hours) load records, either of which can be used to estimate the likely demand on the access point for the immediate future. The database may be stored locally at the access point, or downloaded from a remote server. If such information is not available, the access point switches to the open mode (step S1302) and remains in that mode indefinitely, pending a rise in the demand for its resources (this scenario is discussed further with reference to FIG. 14 below). If information for estimating the future demand in the access point is available, the access point uses that information to determine the maximum duration of a period for which it can operate in the open mode before switching back to the closed mode. At the same time, the access point determines in step S1303 whether it is able to switch to the open immediately, or whether it needs to defer switching for a period of time because, for example, it is expecting a particularly heavy demand for its own resources in the immediate future. In the event that the access point is able to switch modes immediately, it proceeds directly to step S1304 and continues to operate in the open mode until such time as the predetermined period has expired or the demand on the access point's resources rises above a threshold (this scenario is discussed in more detail with reference to FIG. 15 below).

If the access point determines in step S1303 that it needs to wait a certain amount of time before switching to the open mode, the access point will broadcast a signal, indicating its willingness to switch modes in the future (step S1305). The access point then waits until the relevant amount of time has passed and checks whether it has received notification from the neighbouring access point that the offer to switch modes at this later time has been accepted (steps S1306, S1307). In the event that no such notification has been received in that period, the access point remains in the closed mode, returning to step S1102 (or S1202 of FIG. 12). If the access point's offer to switch modes in step S1305 has been accepted, the access point proceeds to step S1304.

FIG. 14 shows an example of steps carried out by the access point following the switch to the open mode in step S1302 of FIG. 13. Having entered the open mode, the access point will continue to operate in that mode indefinitely, pending a change in the demand for its resources from user devices. In step S1401, the access point determines if the demand on the access point's resources is below a threshold that corresponds to that shown in step S1102 of FIG. 11, or the second threshold shown in step S1204 of FIG. 12. If the demand for resources remains below the threshold, the access point continues to operate in the open mode. Conversely, if the demand on the access point's resources rises above the threshold, the access point switches to the closed mode (step S1402).

FIG. 15 shows an example of steps carried out by the access point following the switch to the open mode in step S1304 of FIG. 13. In step S1501, the access point determines if the demand on the access point's resources is above a threshold that corresponds to that shown in step S1102 of FIG. 11, or the second threshold shown in step S1204 of FIG. 12. If the demand for resources is above the threshold, the access point immediately returns to the closed mode (step S1502). If the demand for resources is below the threshold, the access point determines if it has reached the end of the period that was set for operating in the open mode (step S1503). If the period has yet to expire, the access point remains in the open mode until such time as the period has expired or the demand for its resources has risen above the threshold, at which point it switches to the closed mode of operation.

In some embodiments, when switching from one mode to another, the access point may notify other neighbouring access points of its decision to switch modes. The mode-switch decision can be notified between access points directly by reconfiguring parameters in the access point's beacon frame using overlapping basic service set (OBSS) management. Alternatively, such mode-switch notification can be delivered via associated stations that support the ‘beacon request capability’.

As will be understood from the above, precisely if and when an access point switches from the open mode to the closed mode or vice versa will depend on the current mode in which the access point is operating and the demand on both its resources and those of its neighbouring access points.

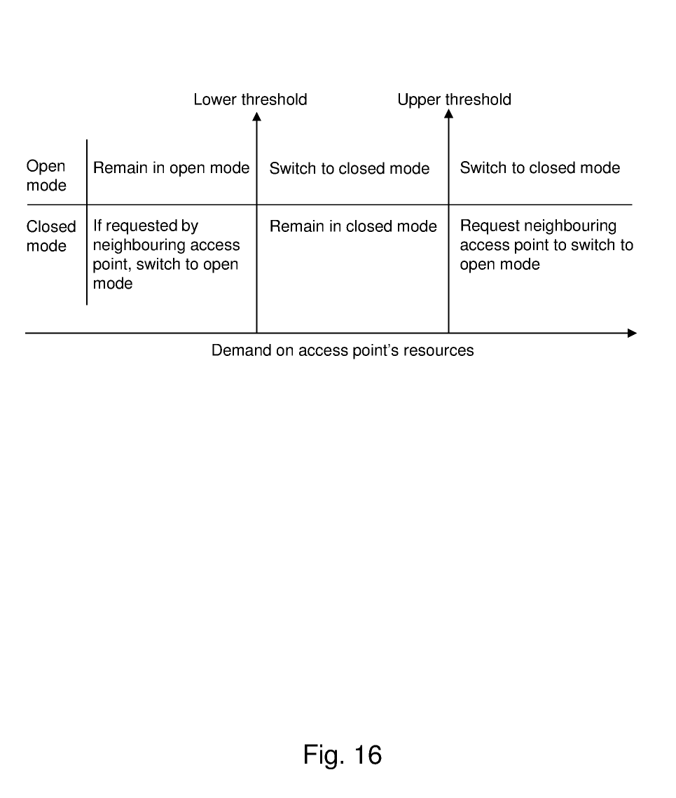

FIG. 16 shows a summary of the different actions taken by the access point when operating under a dual-threshold scheme, such as that shown in FIGS. 6 and 12, for example. The lower threshold may be set as the level at which the access point is “fully loaded” i.e. able to provide required service for user devices that it is currently serving, but having no resources (e.g. bandwidth) available for new connections. The upper threshold may correspond to the level at which the access point is deemed to be “overloaded” i.e. being unable to satisfy the demands for resources (e.g. bandwidth) from user devices that it is currently serving. It will be understood that the above thresholds are given by way of example only; the thresholds may periodically be set at different levels of demand, based on consideration of the different access points' service and data transmission requirements. For example, the level of demand at which a particular access point will be considered to be “fully loaded” and/or “overloaded” may be set in advance, based on the number of access points in the vicinity and/or by taking into consideration past demand for the access point's resources.

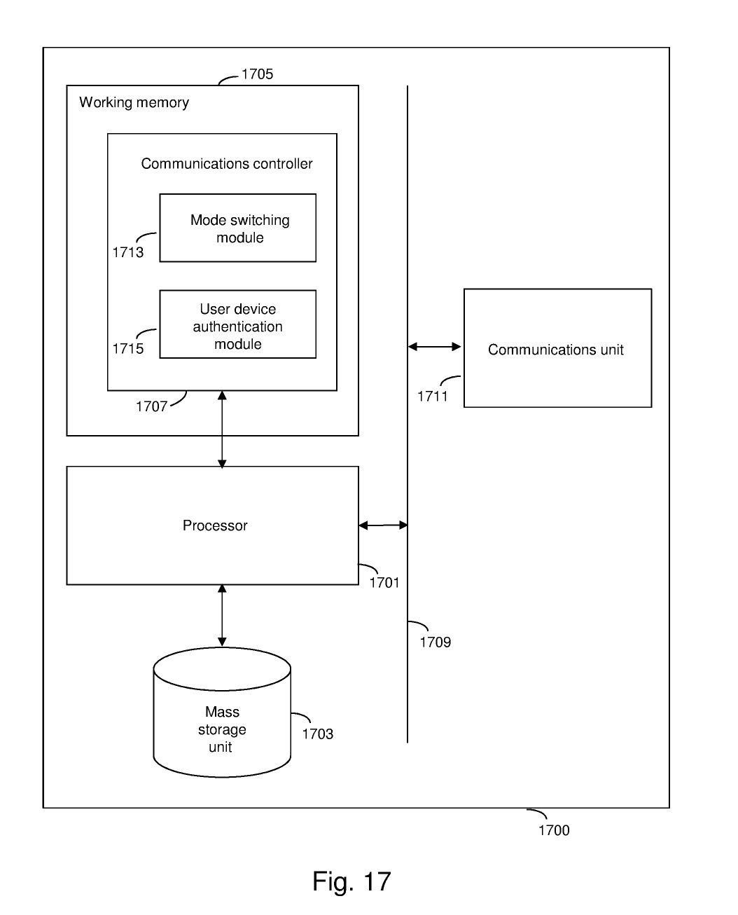

While the reader will appreciate that the above embodiments are applicable to any access point used to facilitate the connection of user devices to a wireless network, a typical access point is illustrated in FIG. 17, which provides means capable of putting an embodiment, as described herein, into effect. As illustrated, the access point 1700 comprises a processor 1701 coupled to a mass storage unit 1703 and accessing a working memory 1705. As illustrated, a communications controller 1707 is represented as a software product stored in working memory 1705. However, it will be appreciated that elements of the communications controller 1707 may, for convenience, be stored in the mass storage unit 1703.

Usual procedures for the loading of software into memory and the storage of data in the mass storage unit 1703 apply. The processor 1701 also accesses, via bus 1709, a communications unit 1711 that operates to effect communications with the wireless network. Typically, the communications unit 1711 will comprises one or more antennas to act as a transmitter and receiver for establishing a communications link with user devices and/or other nodes in the network.

The communications controller 1707 includes a mode switching module 1713 and a user device authentication module 1715. The mode switching module is operable to select the mode (open/closed) in which the access point is to operate, by implementing steps described above in relation to the various embodiments. Thus, execution of the communications controller software 1707 by the processor 1701 will cause embodiments as described herein to be implemented. When operating in the closed mode, the communications controller is operable to execute the user device authentication module; this module is operable to determine whether a not a user device seeking to connect to the access point is in possession of the pre-determined authentication information and acts to ensure that only recognised user devices obtain access to the reserved portion of the access point's resources.

The communications controller software 1707 can be embedded in original equipment, or can be provided, as a whole or in part, after manufacture. For instance, the communications controller software 1707 can be introduced, as a whole, as a computer program product, which may be in the form of a download, or to be introduced via a computer program storage medium, such as an optical disk. Alternatively, modifications to an existing communications controller 1707 can be made by an update, or plug-in, to provide features of the above described embodiment.

Embodiments can be implemented in a distributed manner without a central control on top of access points or WiFi setup of an extended service set, helping to reduce overall cost. Embodiments can effectively deal with heavy load issues and throughput improvement. The use of one or more thresholds for classifying an access point's load conditions can be used to trigger a switch between operating modes. In this way, an access point can switch its access mode between open mode and closed mode in a spectrum-efficient fashion via periodic load check on its own and neighbouring access points' loads

The schemes described herein can be implemented using existing parameters in IEEE standard 802.11-2012 including IEEE standard 802.11aa-2012. For example, the current load or demand for particular resources that an access point is experiencing can be read from ‘BSS Load’ (order 22) in beacon frame body. (Table 8-20, IEEE standard 802.11-2012). The total number of user stations currently associated with an access point can be found in the ‘Station Count’ field of ‘BSS Load’, for example. Signalling between access points, including the issue and acknowledgement/acceptance of mode-switch requests, can be managed in overlapping BSS (OBSS) management via ‘QLoad Report’ (order 57) and ‘HCCA TXOP Update Count’ (order 58) in beacon frame body (802.11aa-2012).

The objective of OBSS management is to facilitate cooperative sharing of the medium between access points that operate in the same channel and that are able to receive or obtain frames from each other, including Beacon frames. These frames might be received directly or via associated stations that support the ‘beacon request Capability’ (see section 10.11.10, 802.11aa-2012). OBSS management also provides the means to enable the coordination of scheduled transmission opportunity (TXOP) between OBSSs.

OBSS management enables stationary and portable access points to provide to neighbouring access points information for the selection of a channel and for the cooperative sharing of that channel. ‘QLoad report’ in the beacon is the main component of OBSS management is that provides information on:
The reporting access point's overlap situation
The reporting access point's QoS traffic load
The total QoS traffic load of BSSs directly overlapping the reporting access point's BSS.

This information might be used to aid an access point when searching for a channel and also when sharing a channel in an overlap situation.

To coordinate the TXOPs of overlapping ‘hybrid coordination function controlled channel access (HCCA)’ access points, OBSS management provides a means of ‘HCCA TXOP Update Count’ in the beacon for an access point to advertise its TXOP allocations so another access point might schedule its own TXOPs to avoid those already scheduled.

In addition, the following parameters in beacon frame body can be used to facilitate the schemes described herein:
‘Beacon interval’ (order 2) can be reconfigured to determine how often a mode switch needs to be carried out.
‘Supported rates’ (order 5) can be reconfigured to limit data rate such that a user device may use its performance metrics to decide to leave its associated access point and select a neighbouring access point to associate with.
‘Capability’ information (order 3) providing encryption and authorisation levels can be reconfigured to manage an access point's load.

Additional features, such as the load database recording and look-up, instructions to switch mode immediately or defer switching, and instructions to switch back to a previous mode after a predetermined period may be implemented as further orders/parameters in a beacon frame body.

It should be appreciated that while the above embodiments are described with reference to Wireless Local Area Networks, this is by way of example only; access points may provide access to other types of network, e.g. cellular networks, particularly femtocells or small cell systems. Embodiments described herein can be easily implemented to balance the loads among the femtocells, where the femtocells can operate in either closed mode or open mode.

While certain embodiments have been described, these embodiments have been presented by way of example only, and are not intended to limit the scope of the invention. Indeed, the novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the inventions.

1. An access point for facilitating connection of one or more wireless user devices to a first communications channel, the access point being operable to allocate resources to user devices seeking to connect to the communications channel, the access point comprising:
a user device authenticator for determining whether a user device connecting to the access point is in possession of pre-determined user device authentication information for obtaining access to the first communications channel;
the access point having first and second modes of operation, wherein in the first mode of operation, the entirety of said resources is available for use by user devices regardless of whether or not the user devices are in possession of the authentication information and in the second mode of operation, the access point is configured to reserve a portion of the resources for user devices that are in possession of the device authentication information;
the access point comprising a mode switching module for switching the mode of operation of the access point, the mode switching module being configured to switch the mode of operation when one or more mode switch criteria are met;
wherein a first one of the mode switch criteria is based on the current demand for resources that the access point is receiving from user devices.

2. An access point according to claim 1, wherein the access point is operable to establish a wireless communications channel through which the one or more user devices may connect to the access point and achieve access to the first communications channel, wherein the resources include the bandwidth of the wireless communications channel;
wherein in the first mode of operation, the entire bandwidth of the wireless communications channel is available for use by user devices regardless of whether or not the user devices are in possession of the authentication information and in the second mode of operation, the access point is configured to reserve a portion of the bandwidth for user devices that are in possession of the device authentication information;
wherein the first one of the mode switch criteria is based on the current demand for the bandwidth that the access point is receiving from user devices.

3. An access point according to claim 1, wherein the mode switching module is configured to assess the level of demand from user devices at successive intervals in time.

4. An access point according to claim 3, wherein when the access point is operating in the first mode and the demand for resources reaches a first threshold during one of the intervals, the mode switching module is configured to immediately switch the access point to the second mode of operation.

5. An access point according to claim 4, wherein when the access point is operating in the first mode and demand for resources reaches a level below the first threshold but above a second threshold during one of the intervals, the mode switching module is configured to determine whether information for estimating a future level of demand on the access point is available;
wherein in the event that the information is not available, the mode switching module is configured to immediately switch the access point to the second mode of operation.

6. An access point according to claim 5, wherein in the event that the access point has switched from operating in the first mode to operating in the second mode and the demand for resources subsequently falls below the second threshold during one of the intervals, the access point is configured to switch the access point back to the first mode immediately.

7. An access point according to claim 5, wherein in the event that the information for estimating a future level of demand is available, the mode switching module is configured to switch the access point to the second mode of operation and to define a maximum period of time for which the access point will remain in the second mode before switching back to the first mode.

8. An access point according to claim 7, wherein the mode switching module is configured to use the information for estimating the future load to determine whether to switch to the second mode immediately, or to defer switching the access point to the second mode for a predetermined period.

9. An access point according to claim 3, wherein when the access point is operating in the second mode and demand for resources reaches a first threshold during one of the intervals, the mode switching module is configured to transmit a mode-switch request to a neighbouring access point having corresponding first and second modes of operation, so as to request the neighbouring access point to switch from the second mode to the first mode of operation.

10. An access point according to claim 3, wherein when the access point is operating in the second mode and the demand for resources remains below a threshold at the end of an interval, the access point is configured to determine if a second mode switch criterion has been met by determining if a mode-switch request has been received from a neighbouring access point in the present interval.

11. An access point according to claim 10, wherein in the event that a mode switch request has been received in the present interval, the mode switching module is configured to determine whether information for estimating a future level of demand is available;
wherein in the event that the information is not available, the mode switching module is configured to immediately switch the access point to the first mode of operation.

12. An access point according to claim 11, wherein in the event that the information for estimating a future level of demand is available, the mode switching module is configured to use the information to determine whether the access point can switch to the first mode immediately, or whether it should delay switching to the first mode of operation by a predetermined period.

13. An access point according to claim 12, wherein in the event the access point determines it should delay switching to the first mode of operation, the access point is configured to inform the neighbouring access point of the delay and to await a response from the neighbouring access point, wherein in the event the access point does not receive a positive response from the neighbouring access point within the predetermined period, the access point is configured to remain in the second mode.

14. An access point according to claim 12, wherein on switching to the first mode, the mode switching module is configured to define a maximum period of time for which the access point will operate in the first mode, before being switched back to the second mode.

15. An access point according to claim 10, wherein when the access point is operating in the second mode and the demand for resources is above the threshold at the end of the interval, the access point is configured to continue operating in the second mode regardless of whether or not a mode-switch request has been received from a neighbouring access point in the present interval.

16. An access point according to claim 1, wherein the access point is configured such that, during operation in the second mode of operation, the portion of the resources that is reserved for user devices that are in possession of the device authentication information can be varied.

17. An access point according to claim 1, wherein when operating in the second mode, the portion of the resources that is reserved for user devices that are in possession of the device authentication information is determined based on the demand for resources from user devices that are connected to the network via the access point and which are in possession of the user device authentication information at the point of switching from the first mode to the second mode.

18. An access point according to claim 4, wherein the first threshold is variable over time.

19. An access point according to claim 5, wherein the second threshold is variable over time.

20. An access point according to claim 10, wherein the threshold is variable over time.
